(19) United States
(12) Patent Application Publication
(10) Pub. No.: US 2003/0012611 A1
(43) Pub. Date: Jan. 16, 2003

(54) High tolerance boring tool with multiple cutting elements

(75) Inventor: John M. Cirino, Kirtland, OH (US)

Correspondence Address: PEARNE & GORDON LLP, 526 SUPERIOR AVENUE EAST, SUITE 1200, CLEVELAND, OH, 44114-1484, US

(73) Assignee: Master Tool Corporation

(21) Appl. No.: 09/904,368

(22) Filed: Jul. 12, 2001

(51) Int. Cl. B23B 51/00

(52) U.S. Cl. 408/1 R; 408/227; 408/231; 408/713

(57) ABSTRACT

A rotary boring tool adapted to include a locator insert for precision positioning of cutting tips provided on multiple cutting elements or inserts is disclosed. The boring tool comprises a tool body, a plurality of replaceable cutting inserts and an insert locator. The tool body includes a first end having a shank portion and a second end having a plurality of cutter insert supports, a plurality of cutter insert recesses and an insert locator recess. The outside surfaces of the shank portion and the flat portions of the insert locator are jig ground to a 0.000 variance relative to a central rotational axis of the tool body. The insert locator is secured to the tool body at a base surface of the insert locator recess. The cutting inserts are secured to the second end of the tool body so that they contact base surfaces of the cutting insert recesses, first radially and axially extending lateral or side surfaces of the cutting insert supports, and the flat portions of the insert locator. When the cutting inserts are secured in the prescribed manner, the cutting tips lie in a plane that is perpendicular to rotational axis and are spaced the same radial distance from the rotational axis. Being so situated, all cutting tips engage a work piece and thereby facilitate rapid and precise production of a bore having virtually no retraction marks and made to a diametral tolerance of 0.0005 inch.

### FIELD OF THE INVENTION

The present invention relates generally to cutting tools, and more specifically, to a rotary boring tool adapted to include a locator insert for precision positioning of multiple cutting elements.

### BACKGROUND OF THE INVENTION

Rotary boring tools configured for boring and finishing holes at high speeds and with rapid axial feed rates are known. Typically, such tools comprise a rotary boring bar having a multiple number of replaceable cutting elements or inserts that are spaced apart around the bar circumference. Ideally, cutting tips provided on these cutting inserts need to be spaced the same radial distance from the bar rotational axis. Such tip spacing maximizes tool efficiency and precision and minimizes tool vibration and retraction marking. While known rotary boring tools employ a variety of means aimed at locating cutting tips in ideal fashion, none of these means have yet to produce a boring tool suitable for fine boring and reaming applications where perfect concentricity and no bore surface marring or damage is desired. The boring tool of the present invention has been found to be an especially effective implement for fine drilling applications where a high level of exactness and no surface marring are of paramount concern.

### SUMMARY OF THE INVENTION

The present invention provides a rotary boring tool adapted so that the tool can be utilized to more rapidly produce in a work piece a hole with tighter dimensional tolerances and less retractional surface marring than can be obtained with heretofore known boring tools. The rotary boring tool of the present invention has an integral body comprising a shank portion located at a first end of the body; a shoulder or flange portion situated axially inward from and adjacent to the shank portion; a first or main body portion positioned axially inward from and adjacent to the flange portion; and a second or fluted body portion located axially inward from and adjacent to the main body portion and at a second end of the body. The shank portion, flange portion, main body portion and fluted body portion are generally cylindrical in form and are further situated on the central rotational axis of the tool body. The shank portion is hollow and is provided with an outer radially curved surface that can be either straight or tapered relative to the central rotational axis of the tool body. In accordance with the invention the straight or tapered surface is jig ground to 0.000 variance relative to the rotational axis of the tool body. The fluted body portion includes an end region that is substantially oriented perpendicular to the rotational axis of the tool body. The end region is provided with a plurality of circumferentially spaced, radially extending recesses capable of receiving a corresponding number of replaceable cutter elements or inserts. The end region is further provided with a cylindrically shaped recess that is centrally located in the end region and that openly communicates at its top with each of the radially extending recesses. The cylindrically shaped recess is capable of receiving a cutting insert locator. The cutting insert locator is a cylindrical structure preferably made of carbide and dimensioned so that the diameter of its outer curved surface is less than the diameter of the cylindrically shape recess and so that the overall height of the insert locator is greater that the depth of the cylindrically shaped recess. The cutting insert locator is provided with a central axial bore and a central counter bore. The cutting insert locator is removably secured against a bottom surface of the cylindrically shaped recess by inserting a threaded fastening means such as a cap screw first through the central axial bore and counter bore of the locator insert and then into a threaded bore provided in the bottom surface of the cylindrical recess. Prior to being so secured, the outer curved surface of the cutting insert locator is, like the outer surface of the shank portion, jig ground to provide flats having a 0.000 variance and the top edge of the cutting insert locator is provided with a chamfer. Each of the cutting inserts, which are polygonal in form and dimensionally the same, are provided with a cutting tip situated on an outer comer of the insert. Each of the cutting inserts, and hence each cutting tip provided therewith, is insertable into each of the radially extending recesses and relative to the cutting insert locator. This aspect of the cutting inserts makes it possible for a face of the cutting inserts, that is located radially inward relative to the cutting tip, to be abutted against the jig ground flats of the cutting insert locator and for the cutting tips provided on the inserts to be spaced the same radial distance away from the central rotational axis of the boring tool body.

### BRIEF DESCRIPTION OF THE DRAWINGS

FIG. 1 is an enlarged and exploded perspective view of a rotary boring tool of the present invention;

FIG. 2 is an enlarged side elevational view of the central cylindrical recess shown in FIG. 1 and of the locator insert shown in FIG. 1; and

FIG. 3 is a cross-sectional view of a hole made by the rotary boring tool of the present invention.

### DETAILED DESCRIPTION OF THE INVENTION

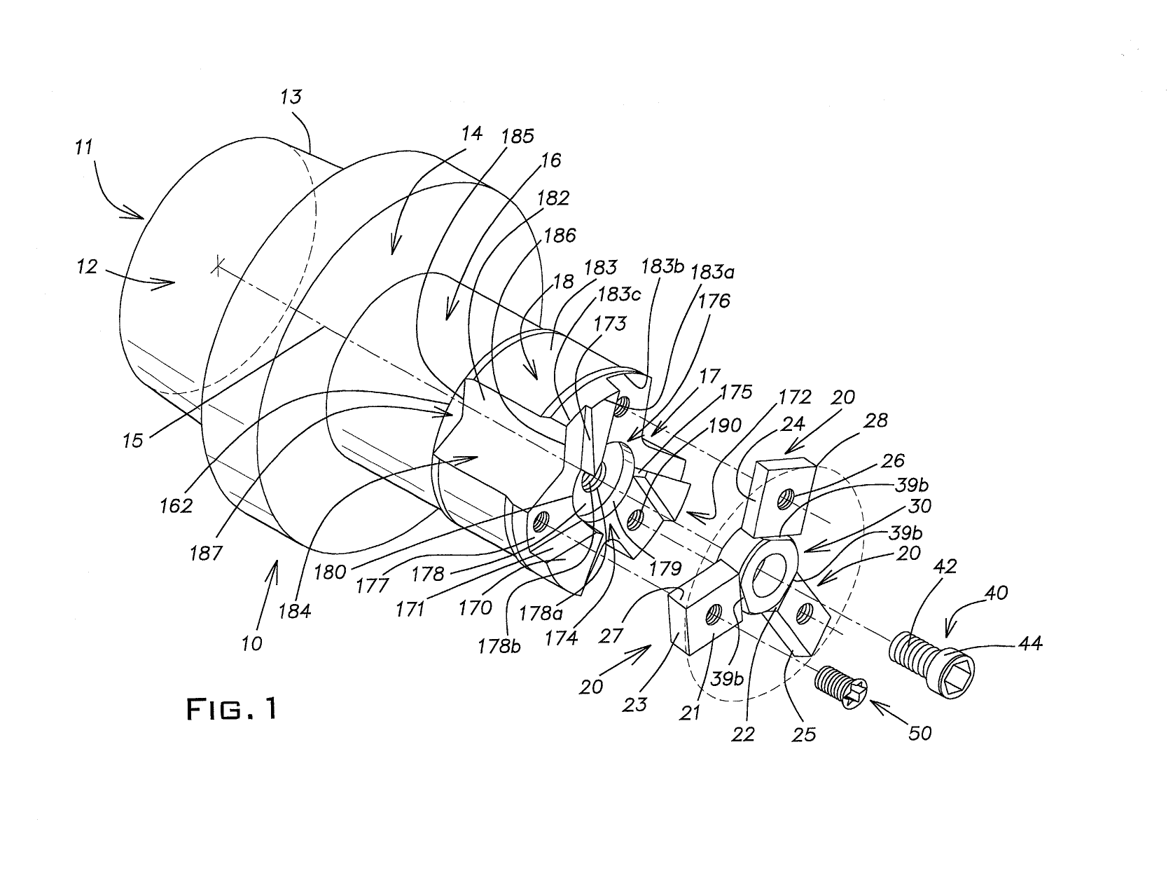

A rotary boring tool according to the present invention is shown in FIG. 1 and is designated generally by the reference number 1. The boring tool 1, which is especially well suited for producing engine cylinder bores, has been selected to serve as an illustrative example of the invention. The invention may just as easily and effectively be applied to a multitude of other rotary boring tools utilized for other applications.

As most clearly shown by FIG. 1, the boring tool 1 generally comprises an elongated, shaft like tool body 10, a plurality of replaceable cutting elements or inserts 20 and a cutting insert locator 30. The tool body 10 integrally includes a shank portion 12, a shoulder or flange portion 14, a first or main body portion 16, and a second or fluted body portion 18. The shank portion 12 is located at a first end 11 of the tool body 10. The shoulder or flange portion 14 is situated axially inward from and adjacent to the shank portion 12. The first or main body portion 16 is positioned axially inward from and adjacent to the flange portion 14. The second or fluted body portion 18 is located axially inward from and adjacent to the first or main body portion 16 and at a second end 17 of the tool body 10. The shank portion 12, flange portion 14, main body portion 16 and fluted body portion 18 are generally cylindrical in form and are further situated on a longitudinally extending, centrally located rotational axis 15 of the tool body 10. The shank portion 12 is hollow and has an inside wall (not shown) that is configured to permit the tool body 10 to be connected to a rotary shaft of a known drilling apparatus (neither shaft nor drilling apparatus shown). The shank portion 12 further has an outer radially curved surface 13 that, when viewed squarely from the side of the shank portion 12, i.e., from a direction that is perpendicular to the central rotational axis 15, can be either straight or conically tapered relative to the axis 15 of the tool body 10. In the case where the radially curved surface 13 is conically tapered relative to the axis 15, the taper is preferably oriented so that the outside diameter of the curved surface 13 progressively diminishes in the direction of the first end 11 of the tool body 10. In accordance with the present invention, the straight or tapered configuration of the radially curved surface 13 is produced by jig grinding the surface 13 to a tolerance of 0.000 inches relative to the rotational axis 15 of the tool body 10.

The fluted body portion 18 includes a plurality of chip removal side walls 182. The sidewalls define a series of chip removal flutes 184 that, as those persons skilled in the relevant art will recognize, serve to facilitate extraction of work piece particles as the boring process is carried out. The side walls 182 protrude inwardly toward the rotational axis 15 and extend axially along the fluted body portion 18. Additionally, the side walls 182, and hence the flutes 184 defined thereby, are circumferentially spaced apart relative to the outer surface 183 of the fluted body portion 18. Each of the side walls 182 has a first edge 185 and a second edge 186 that is axially spaced apart from the first edge 185. Each first edge 185 cooperates with an arcuate edge portion 162 of the main body portion 16 to define a radially extending flute root 187. The second edge 186 of each of the side walls 182 is shared with the second end 17 of the tool body 10 in a way that hereinafter will be described.

The second end 17 of the tool body 10 comprises a number of individual surfaces that cooperate to define a plurality of cutting insert supports 172, a plurality of cutting insert recesses 174 and a cutting insert locator recess 176. FIG. 1 shows that the cutting insert supports 172 are defined by an outwardly arcuate, axially extending appendage 183a of the outer surface 183 of the fluted body portion 18, a radially extending surface 170 having an outline resembling a truncated circular segment, a first radially and axially extending lateral or side surface 171, a second radially and axially extending lateral or side surface 173, and an axially extending surface 175 that may be either outwardly arcuate or flat.

Each of the cutting insert recesses 174 is predominately defined by one of a plurality of boomerang-shaped flat surfaces 177 and by one of the first side surfaces 171 and one of the second side surfaces 173. It will be noted that the outer periphery of the flat surface 177 is delineated by the second edge 186 of the side wall 182 and by an edge segment 183b and yet another edge segment 183c of the outer surface 183 of the fluted body portion 18. It will further be noted that, instead of being perpendicularly oriented relative to the rotational axis 15, each of the surfaces 177 is skewed relative to the axis 15 in a manner so that they are inclined by a slope that extends axially outward relative to the corresponding flute root 187. The inclined surfaces 177 serve to orient the cutting inserts 20 in a manner that hereinafter will be described.

The cutting insert locator recess 176 is cylindrically shaped and centrally located on the second end 17 of the tool body 10. The recess 176 is essentially defined by a flat base surface 178 that is oriented perpendicularly to the rotational axis 15 and by a curved side wall 179 that extends axially outward from the base surface 178 and that defines a circular edge 180 where the curved side wall 179 intersects the base surfaces 177 of the cutting insert recesses 174 and the axially extending surfaces 175 of the cutting insert supports 172. The base surface 178 of the recess 176 is provided with a central opening 178a that leads to a threaded bore 178b that is situated concentrically with the rotational axis 15 and that extends axially into the fluted body portion 18 of the tool body 10. The threaded bore 178b serves to receive a cap screw 40 used in a manner that hereinafter will be described. For ultra precision boring, the curved side wall 179 is preferably jig ground to a radial tolerance of 0.0001 inch.

The replaceable cutting elements or inserts 20 are polygonal bodies that generally are comprised of a plurality of planar surfaces. The plurality of planar surfaces include the top sides 21, bottom sides (not shown and hence unnumbered), inner faces 22, outer faces 23, first lateral or side faces 24, and second lateral or side faces 25. The top sides 21 and the bottom sides are substantially parallel to one another, have similar outlines generally resembling a parallelogram, and further have surface openings defined by the side walls of threaded bores 26 that extend between the top sides 21 and the bottom sides of the inserts 20. The inner faces 22 are oriented at right angles relative to the top sides 21 and the bottom sides of the inserts 20. The first lateral faces 24 are angled so that they form an acute angle relative to the top sides 21 and a complementary obtuse angle relative to the bottom sides of the inserts 20. The second lateral faces 25 are provided with notches 27 that extend between the top sides 21 and the bottom sides of the inserts 20 and that, along with comer portions of the top sides 21 and the outer faces 23, form cutting tips 28.

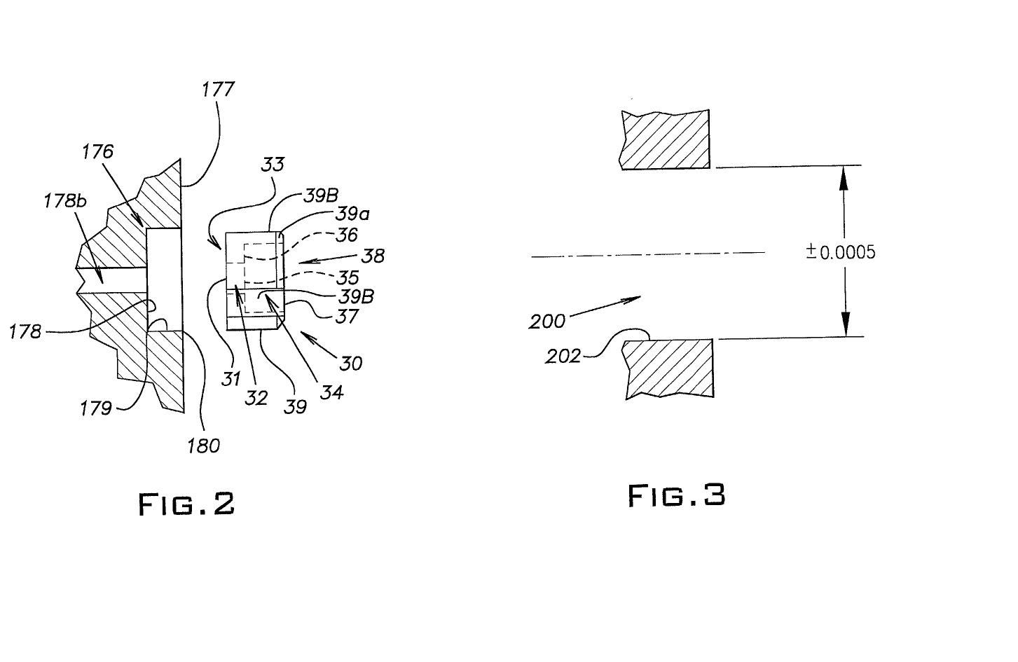

The cutting insert locator 30 is preferably manufactured from carbide steel and is a generally cylindrical component having a height that is substantially greater than the depth of the cutting insert locator recess 176 and an outside diameter that is slightly smaller than diameter of the locator recess 176. As shown by FIGS. 1 and 2, the insert locator 30 is provided with a central bore 32 and a counter bore 34 that is concentrically aligned with the central bore 32. As indicated by FIG. 2, the central bore 32 has an opening 31 situated at a first end surface 33 of the insert locator 30. The central bore 32 has yet another opening 35 located at a base surface 36 of the counter bore 34. Lastly, the counter bore 34 has an opening 3 7 positioned at a second end surface 38 of the insert locator 30. When the insert locator 30 is inserted into the recess 176, the openings 31, 35 and 37 become concentrically aligned with the central opening 178a provided in the base surface 178. Alignment of the openings 31, 35 and 37 makes it possible for a threaded portion 42 of the cap screw 40 to be received by the central bore 32 and a head portion 44 of the cap screw to be received by the counter bore 34. Alignment of the openings 31, 35 and 37 further makes it possible for the threaded portion 42 of the cap screw 40 to be screwed into the bore 178b provided in the fluted body portion 18 and for the insert locator to be secured to the tool body 10 by causing the first end surface 33 of the insert locator to be firmly pressed against the base surface 178 of the recess 176 when an annular bottom surface of the head portion of the cap screw 40 makes contact with the base surface 36 of the counter bore 34.

Prior to securing the insert locator 30 to the tool body 10 in the just described manner, the outer curved surface 39 of the locator 30 is jig ground to provide flats 39b having a tolerance of 0.000 inches relative to the rotational axis 15 of the tool body 10 and a chamber 39a is additionally provided. Next, the cutting inserts 20 are positioned on and secured to the tool body 10. Positioning and securing the cutting inserts 20 entails slidably placing the inserts 20 into the cutting insert recesses 174 so that the bottom sides of the inserts 20 make flat contact with the base surfaces 177 of the recesses 176, so that the first lateral faces 24 of the inserts 20 make flat contact with the first radially and axially extending lateral or side surfaces 171 of the cutting insert supports 172, and so that the inner faces 22 of the inserts 20 make flat contact with the flats 39b of the insert locator 30. When the bottom sides, first lateral faces 24 and inner faces 22 are caused to contact the base surfaces 177, the first radially and axially extending lateral or side surfaces 171, and the flats 39b in the just described manner, the threaded bores 26 become respectively aligned with threaded bores 190 provided in the base surface 177. With the bores 26 and the bores 190 being in alignment, attachment screws 50 (only one screw shown) are screwed into the bores 26 and the bores 190 so that the bottom sides of the cutting inserts become firmly pressed against the base surfaces 177 and so that the first lateral faces 24 and the inner faces 22 of the inserts 20 will respectively remain in contact with the first radially and axially extending lateral or side surfaces 171 of the cutting insert supports 172 and with the flats 39b of the insert locator 30.

When the cutting inserts 20 are positioned and secured in the just described manner, the cutting tips 28 of the notches 27 will lie in a plane that is perpendicular to the rotational axis 15 of the tool body 10. All of the tips 28 will be located at the same radial distance relative to the rotational axis 15, and because the base surfaces 177 are skewed relative to the rotational axis 15 and are inclined outwardly relative to the flute root 187, all of the tips 28 are located further axially outward than any point or surface of the second end 17 of the tool body 10. These aspects of the cutting tips 28 ensure that all of the tips 28 are simultaneously engaged with the work piece and that a hole can be bored in the shortest time possible, to very tight tolerances, and with virtually no marring of the bore side wall when the boring tool 1 is retracted from the bore. As indicated by FIG. 3, the boring tool 1 of the present invention can be utilized to produce an engine cylinder bore 200 having a side wall 202 bored to a diametral tolerance of 0.0005 inch.

While a preferred embodiment of the invention has been described above, it will be recognized and understood that various modifications may be made therein and the appended claims are intended to cover all such modifications that may fall within the spirit and scope of the invention. It will further be recognized that, while the present invention has been described in the context of a rotary boring tool having three cutting inserts, the present invention is not intended to be limited to a boring tool having any specific number of cutting inserts. All that is necessary is that the boring tool have two or more inserts in order that it can come within the scope of the present invention.

1. A rotary boring tool used for making a bore in a work piece, said tool comprising: a tool body having a shank portion located at a first end of said tool body, a fluted body portion located at a second end of said tool body and a longitudinally extending, central rotational axis passing through said first end of said tool body, said shank portion, said fluted body portion, and said second end of said tool body; a plurality of cutting elements secured to said second end of said fluted body portion; and a cutting insert locator attached to said second end of said tool body and abutting said plurality of cutting inserts.

2. A rotary boring tool according to claim 1, wherein said shank portion is a cylindrical shank portion and said fluted body portion is a cylindrical fluted body portion, said cylindrical shank portion being located at said first end of said tool body so that said longitudinally extending, central rotational axis of said tool body coincides with a longitudinally extending, central axis of said cylindrical shank portion and said cylindrical fluted body portion being located at said second end of said tool body so that said longitudinally extending, central rotational axis of said tool body coincides with a longitudinally extending, central axis of said cylindrical fluted body portion.

3. A rotary boring tool according to claim 2, wherein said cylindrical shank portion has a curved outside shank surface, said curved outside shank surface being jig ground to a tolerance of 0.000 inch relative to said longitudinally extending, central rotational axis of said tool body.

4. A rotary boring tool according to claim 2, wherein said second end of said tool body includes a plurality of radially and axially extending cutting insert supports, a plurality of cutting insert recesses adjoining said cutting insert supports and a cutting insert locator recess adjoining said plurality of cutting insert supports and said plurality of said cutting insert recesses.

5. A rotary boring tool according to claim 4, wherein said cutting insert locator recess is a cylindrical cutting insert locator recess having an insert locator recess base that is flat and is oriented perpendicularly to said longitudinally extending, central rotational axis of said tool body; a longitudinally extending insert locator recess central axis that coincides with said rotational axis of said tool body, and a cutting insert locator recess side wall that is curved and extends axially outward from said insert locator base to an axially outer circular edge of said recess side wall.

6. A rotary boring tool according to claim 5, wherein said cutting insert locator is a cylindrical cutting insert locator having an insert locator base, an insert locator outer surface having a plurality of flats and a longitudinally extending insert locator central axis, said insert locator base having an overall diameter that is smaller than the inside diameter of said cylindrical cutting insert locator recess and said insert locator outer surface having an axial height that is substantially greater than the axial depth of said cylindrical cutting insert locator recess.

7. A rotary boring tool according to claim 6, wherein said cutting insert locator recess receives said cylindrical cutting insert locator so that said insert locator base contacts said insert locator recess base; a first portion of said insert locator outer surface adjoining said insert locator base contacts said insert locator recess side wall; a second portion of said insert locator outer surface adjoining said first portion protrudes axially out of said cutting insert locator recess; and said longitudinally extending cutting insert locator central axis coincides with said longitudinally extending cutting insert locator recess axis.

8. A rotary boring tool according to claim 7, wherein said second portion of said insert locator outer surface include said flats, said flats being jig ground to provide the insert locator with outer surfaces having a tolerance of 0.000 inch relative to said central rotational axis of said tool body.

9. A rotary boring tool according to claim 8, wherein said plurality of cutting inserts abut said jig ground insert locator outer surfaces.

10. A rotary boring tool according to claim 8, said insert locator outer surface includes a chamfer.

11. A rotary boring tool according to claim 7, wherein said cylindrical cutting insert locator further has an insert locator central bore and an insert locator counter bore, said insert locator counter bore being concentrically aligned with said insert locator central bore.

12. A rotary boring tool according to claim 11, wherein said insert locator central bore and said insert locator counter bore become aligned with an insert locator recess central bore when said cutting insert locator is received by said cutting insert locator recess, and said insert locator central bore and said insert locator counter bore and said insert locator recess central bore receive a fastening means to secure said cylindrical cutting insert locator in said cutting insert locator recess.

13. A rotary boring tool according to claim 12, wherein said insert locator recess central bore is a threaded bore and said fastening means is a cap screw having a threaded portion received by said threaded cutting insert recess central bore and a head portion received by said insert locator counter bore.

14. A rotary boring tool according to claim 9, wherein said cutting insert supports are defined by: an outwardly arcuate, axially extending appendage of an outer surface of said fluted body portion; a radially extending surface having an outline resembling a circular segment with a truncated end, said radially extending surface being adjoined by said outwardly arcuate, axially extending appendage of an outer surface of said fluted body portion; a first radially and axially extending lateral surface adjoined by said outwardly arcuate, axially extending appendage of an outer surface of said fluted body portion and by said radially extending surface having an outline resembling a circular segment with a truncated end; a second radially and axially extending lateral surface also adjoined by said outwardly arcuate, axially extending appendage of an outer surface of said fluted body portion and by said radially extending surface having an outline resembling a circular segment with a truncated end; and an axially extending surface adjoined by said radially extending surface having an outline resembling a circular segment with a truncated end and by said first radially and axially extending lateral surface and second radially and axially extending lateral surface.

15. A boring tool according to claim 14, wherein said cutting inserts abut said first radially and axially extending lateral surface of said cutting insert supports.

16. A rotary boring tool according to claim 15, wherein said cutting insert recesses are defined by an insert recess base surface, by one of said first radially and axially extending lateral surfaces of a first cutting insert support included in said plurality of cutting insert supports and by one of said second radially and axially extending lateral surface of a second cutting insert support included in said plurality of cutting insert supports.

17. A rotary boring tool according to claim 16, wherein said cutting inserts abut said insert recess base surface of said cutting insert recesses.

18. A rotary boring tool according to claim 17, wherein said cutting inserts include a plurality of cutting tips, said cutting tips lying in plane that is perpendicular to said longitudinally extending, central rotational axis of said tool body and being located at a same radial distance from said central rotational axis.

19. A rotary boring tool according to claim 5, wherein said insert locator recess side wall is bored to a diametral tolerance of ±0.0004 inch, or better.

20. A rotary boring tool according to claim 18, wherein said bore in said work piece is bored by said cutting tips to a diametral tolerance of 0.0005 inch.

21. A method for locating a plurality of cutting tips on a plurality of cutting inserts at a same radial distance from a longitudinally extending, central rotational axis of a tool body of a rotary boring tool, said method including the steps of: jig grinding to a tolerance of 0.000 inch an outer curved surface of a cylindrical shank portion located at a first end of said tool body and having a longitudinally extending, central shank axis that coincides with said central rotational axis of said tool body; inserting a cylindrical cutting insert locator into a cylindrical cutting insert locator recess provided in a cylindrical fluted body portion located at a second end of said tool body and having a longitudinally extending, central fluted body axis the coincides with said central rotational axis of said tool body; providing a plurality of flats on said cylindrical insert locator by jig grinding to a tolerance of 0.000 inch an outer curved surface of said cylindrical cutting insert locator; securing said cylindrical cutting insert locator within said cylindrical cutting insert locator recess so that a longitudinally extending, central axis of said insert location is concentric with said longitudinally extending, central rotational axis of said tool body; abutting said plurality of cutting inserts against said flats of said cylindrical cutting insert locator; abutting said cutting inserts against a plurality of cutting inserts supports provided at said second end of said tool body; abutting said cutting inserts against a plurality of cutting insert recesses also provided at said second end of said tool body; and securing said cutting inserts to a base surface of said cutting insert recesses so that said cutting inserts become stationary relative to said flats of said cutting insert locator, a first radially and axially extending lateral surface of said cutting insert supports and a base surface of said cutting insert recesses.
